(19) United States
(12) Patent Application Publication
(10) Pub. No.: US 2022/0379599 A1
(43) Pub. Date: Dec. 1, 2022

(54) PRINTING APPARATUS AND PRINT PRODUCING METHOD

(71) Applicant: SEIKO EPSON CORPORATION, Tokyo (JP)

(72) Inventor: Kenichi NAKANO, Shiojiri (JP)

(21) Appl. No.: 17/664,885

(22) Filed: May 25, 2022

(30) Foreign Application Priority Data
May 27, 2021 (JP) 2021-089074

(51) Int. Cl. B41J 2/045; G06F 3/12; B41J 11/66

(52) U.S. Cl. CPC B41J 2/0451; G06F 3/1253; G06F 3/1208; G06F 3/121; B41J 11/663; B41J 2/04586

(57) ABSTRACT

A printing apparatus according to an aspect includes a printing mechanism and a control section configured to control the printing mechanism to form a different margin according to presence or absence of an abnormality of the printing mechanism and a degree of the abnormality.

The present application is based on, and claims priority from JP Application Serial Number 2021-089074, filed May 27, 2021, the disclosure of which is hereby incorporated by reference herein in its entirety.

### BACKGROUND

### 1. Technical Field

The present disclosure relates to a printing apparatus and a print producing method.

### 2. Related Art

In a printing apparatus, a printing failure sometimes occurs because of, for example, an abnormality of a printing mechanism. In a recording apparatus capable of cutting a mount, there has been known a technique for, when a label on which a recording failure is detected is included in the mount, cutting the mount in a position different from a cutting position where the mount is cut when the label is not included in the mount (for example, JP-A-2014-8741 (Patent Literature 1)).

When an abnormality is present in the printing mechanism, a degree of the abnormality could be different. However, a user cannot learn the degree of the abnormality with the related art.

### SUMMARY

A printing apparatus according to an aspect includes: a printing mechanism including: a print head configured to perform printing on a printing medium; and a conveying mechanism configured to convey the printing medium; a detecting section configured to detect an abnormality of the printing mechanism; and a control section configured to control the printing mechanism to form a different margin according to presence or absence of the abnormality of the printing mechanism and a degree of the abnormality.

A printing method according to an aspect includes, in a printing apparatus including: a printing mechanism including: a print head configured to perform printing on a printing medium; and a conveying mechanism configured to convey the printing medium; a detecting section configured to detect an abnormality of the printing mechanism; and a control section configured to control the printing mechanism, the control section controlling the printing mechanism to form a different margin according to presence or absence of the abnormality of the printing mechanism and a degree of the abnormality and performing printing on the printing medium.

### BRIEF DESCRIPTION OF THE DRAWINGS

FIG. 1 is a block diagram of a printing apparatus.

FIG. 2 is a schematic diagram showing disposition of a printing mechanism.

FIG. 3 is a diagram showing a user interface for performing setting concerning a margin.

FIG. 4 is a flowchart showing print processing.

FIG. 5 is a flowchart showing the print processing.

FIG. 6 is a diagram showing cutting positions for not leaving margins.

FIG. 7 is a diagram showing cutting positions for leaving margins.

FIG. 8 is a diagram showing lengths of margins corresponding to presence or absence and degrees of abnormalities.

### DESCRIPTION OF EXEMPLARY EMBODIMENTS

An embodiment of the present disclosure is explained according to order described below:

1. Configuration of a printing apparatus;

2. Print processing; and

3. Other embodiments.

### 1. CONFIGURATION OF A PRINTING APPARATUS

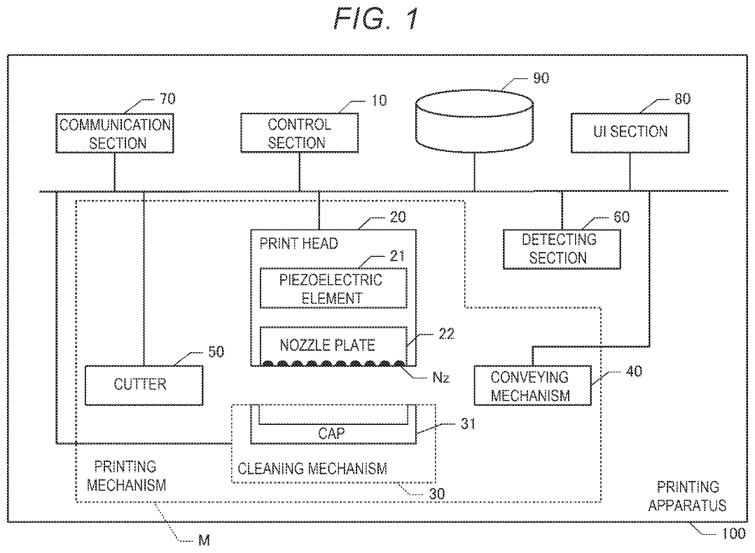

FIG. 1 is a block diagram showing the configuration of a printing apparatus 100 according to the embodiment of the present disclosure. The printing apparatus 100 includes a control section 10, a printing mechanism M, a detecting section 60, a communication section 70, a UI section 80, and a nonvolatile memory 90. The printing mechanism M includes a print head 20, a cleaning mechanism 30, a conveying mechanism 40, and a cutter 50.

The control section 10 includes a processor, a RAM, and a ROM not shown in FIG. 1. The control section 10 can execute various programs recorded in the nonvolatile memory 90 and control the sections of the printing apparatus 100. The control section 10 may be configured by a single chip or may be configured by a plurality of chips. As the processor, for example, a CPU or an ASIC may be adopted or the CPU and the ASIC may cooperate.

The print head 20 includes a piezoelectric element 21, a nozzle plate 22, and a nozzle Nz. The print head 20 receives supply of ink from a not-shown ink tank and discharges ink droplets of the ink from the nozzle Nz. The print head 20 includes a plurality of nozzles Nz. The nozzles Nz are arrayed along a plane of the nozzle plate 22 having a flat shape opposed to a not-shown printing medium in parallel. Each of the plurality of nozzles Nz and a not-shown ink chamber communicate. The ink is supplied to the ink chamber from the ink tank. A driving pulse output from a not-shown driving signal generation circuit is applied to the piezoelectric element 21 included in each ink chamber. The piezoelectric element 21 is mechanically deformed by the driving pulse and pressurizes and depressurizes the ink in the ink chamber to thereby discharge the ink droplets from the nozzles Nz.

The print head 20 is mounted on a not-shown carriage and reciprocates. A direction of the reciprocation is referred to as main scanning direction. The printing medium is conveyed in a direction orthogonal to the main scanning direction by the conveying mechanism 40. The direction in which the printing medium is conveyed is referred to as sub-scanning direction, conveying direction, or the like. Color inks are discharged from the nozzles Nz in a process of moving the carriage in the main scanning direction, whereby an image can be printed on the printing medium. It is possible to print an image in any position in a printable range in the printing medium by repeating the conveyance of the printing medium by the conveying mechanism 40, the movement of the carriage, and the discharge of the ink from the print head 20.

The cleaning mechanism 30 is a mechanism that cleans the nozzles Nz. In this embodiment, the cleaning mechanism 30 includes a cap 31 opposed to the nozzles Nz formed in the nozzle plate 22 and a not-shown mechanism for supporting the cap 31 and changing the position of the cap 31 with respect to the nozzle plate 22 of the print head 20. The cap 31 is disposed in a home position of the print head 20. The home position is a standby position of the print head 20 that does not implementing printing. The cap 31 can perform capping when the carriage mounted with the print head 20 moves to the home position. The cap 31 includes a bottom section and a sidewall section erected from the peripheral edge of the bottom section and has a box shape, the upper surface of which opposed to the nozzle plate 22 is opened. At the capping time, the cap 31 moves to the nozzles Nz side such that the nozzles Nz face a space surrounded by the bottom section and the sidewall section.

A sheet-like moisturizing member made of a porous material such as felt or sponge is disposed in the bottom section of the cap 31. In this embodiment, continuously discharging a default amount of ink droplets from the nozzles Nz is referred to as flushing operation. The ink impacts the moisturizing member at a flushing operation time. Evaporation of an ink solvent from the nozzles Nz can be suppressed by the moisturizing member at the capping time. A not-shown waste liquid tube is coupled to a space of the cap 31. A not-shown suction pump is coupled to the waste liquid tube. The operation of the suction pump is controlled by the control section 10. When the suction pump is operated in a state in which an opening edge of an upper part of the cap 31 adheres to the nozzle plate 22, a sucking operation for sucking the ink and the air in the print head 20 from the cap 31 side through the nozzles Nz can be implemented. In this embodiment, an eliminating operation for eliminating clogging of the nozzles Nz includes at least one of the flushing operation and the sucking operation. The cleaning may be implemented by another form, for example, wiping.

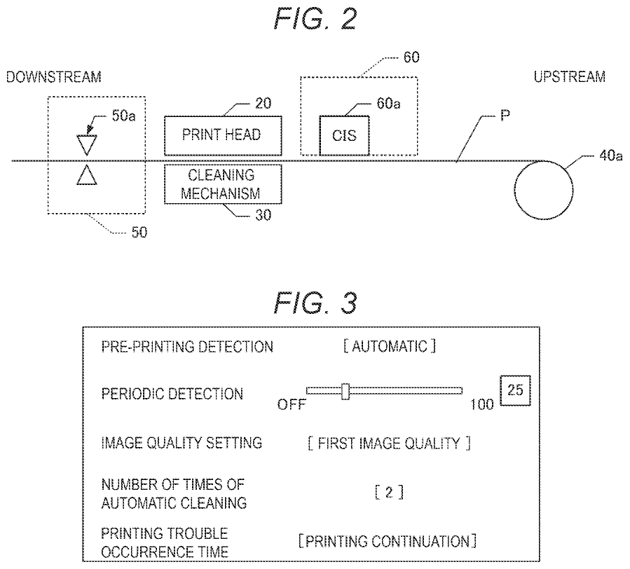

The conveying mechanism 40 is a mechanism for conveying a printing medium in the sub-scanning direction perpendicular to the main scanning direction. The cutter 50 is a mechanism for cutting the printing medium on which printing is performed. The detecting section 60 is a device for detecting an abnormality of the printing mechanism M. FIG. 2 is a diagram schematically showing a conveying path for the printing medium and a mechanism around the conveying path. The conveying mechanism 40 can be configured by various forms. In this embodiment, the conveying mechanism 40 pulls out and conveys a printing medium P stored in a roll form.

That is, the printing medium P is stored in a wound state around a rotation axis and configures a medium roll 40a. The printing medium P is held by not-shown rollers and pulled out from the medium roll 40a to thereby be conveyed along a default conveying path. In FIG. 2, the conveying path is linearly shown. However, it goes without saying that the conveying path is not limited to the linear configuration.

In this embodiment, the detecting section 60, the print head 20, and the cutter 50 are disposed along the conveying path from an upstream toward a downstream of the conveying path for the printing medium P. In FIG. 2, the position of a blade 50a included in the cutter 50 is schematically indicated by a triangle. As shown in FIG. 2, the blade 50a of the cutter 50 is disposed further downstream than the print head 20 along the conveying path. Therefore, the cutter 50 can cut the printing medium P printed by the print head 20 further downstream than the print head 20. The printing medium P is cut to be a rectangular print.

In this embodiment, the detecting section 60 detects clogging of the nozzles Nz included in the print head 20 as an abnormality of the printing mechanism M. The clogging of the nozzles Nz may be detected by various methods. In this embodiment, the clogging of the nozzles Nz is detected based on an image printed on a printing medium. In this embodiment, the detecting section 60 includes a CIS (Contact Image Sensor) 60a. The CIS 60a scans a default check pattern printed by the print head 20 and outputs a read image to the control section 10. The control section 10 detects, based on the image, a shift of the read image from a reference and specifies, based on the shift, whether clogging of the nozzles Nz has occurred.

The abnormality of the printing mechanism M is not limited to the clogging of the nozzles Nz and may be an abnormality in a direction in which the ink discharged from the nozzles Nz flies or may be other abnormalities. A method of detecting an abnormality is not limited to the scanning of the image and may be, for example, a method of detecting the clogging of the nozzles Nz with, for example, a current amount flowing to the piezoelectric element 21 included in the print head 20. Further, the clogging may be detected by combining these methods.

The communication section 70 includes a communication interface for communicating with external equipment according to wired or wireless various communication protocols. The communication section 70 includes an interface for communicating with various removable memories attached to the printing apparatus 100. The printing apparatus 100 is capable of communicating with a print job generation device such as a personal computer, a smartphone, or a tablet via the communication section 70. Print job data transmitted from the print job generation device is temporarily stored in the nonvolatile memory 90.

The UI section 80 includes a touch panel display and various keys and switches. The touch panel display includes a display panel that displays various kinds of information based on control of the control section 10 and a touch detection panel superimposed on the display panel. The touch panel display detects touch operation by a human finger or the like. The control section 10 can acquire operation content of a user via the UI section 80. The control section 10 can display various kinds of information on the display of the UI section 80 and notify the user of the information.

When performing printing, the control section 10 acquires a print job from the print job generation device or the removable memory via the communication section 70. When the print job is acquired, the control section 10 performs image processing based on printing data indicating the print job and generates image data to be printed on a printing medium. Further, the control section 10 controls the conveying mechanism 40 to convey the printing medium to a printing position by the print head 20. Further, the control section 10 determines, based on the image data, timing for applying a pulse to the nozzles Nz and a type of the applied pulse. In a process for causing the carriage and the conveying mechanism 40 to operate, the control section 10 applies a pulse to the piezoelectric element 21 and causes the nozzles Nz to discharge the ink.

When the printing is performed, in this embodiment, the control section 10 controls the conveying mechanism 40 to convey the printing medium after the printing to a cutting position by the cutter 50. The control section 10 controls the cutter 50 to cut the printing medium in the cutting position. The cutting may be implemented every time printing for one page is performed or may be implemented when a cutting part of the printing medium reaches the cutting position by the cutter 50 in a process for performing printing of a print job for a plurality of pages.

In this embodiment, in at least any one of pre-execution, post-execution, and an execution process of the print job, the control section 10 can execute processing for detecting an abnormality of the printing mechanism M. Timing for performing the detection may be determined in advance or may be selected by the user. In this embodiment, the detection is performed according to selection by the user.

FIG. 3 is an example of a user interface for performing selection. In the example shown in FIG. 3, it is possible to set, for example, whether the detection is performed before the execution of the print job. Specifically, in an item of pre-printing detection, the user can set whether the detection is automatically performed before the execution of the print job. In an item of periodical detection, the user can set whether the detection is automatically performed in an execution process of the print job. When the detection is performed, the user can further set a frequency of the detection. In the example shown in FIG. 3, an example is shown in which the detection frequency can be specified by the number of printing pages. For example, 25 indicates that the detection is performed once every time twenty-five pages of a printing medium having a regular size are printed. The user can change a numerical value of the detection frequency from 0 (OFF) to 100 with operation on a slide bar.

In an item of image quality setting, the user can set image quality of an image printed on a printing medium. The image quality depends on the number of pieces of clogging of the nozzles Nz that occur when the image is printed and a degree of being able to reduce influence due to the clogging of the nozzles Nz with supplementation explained below. In this embodiment, when clogging occurs in the nozzles Nz, processing for supplementing ink that should be discharged from the clogged nozzles Nz with the ink from the unclogged nozzles Nz is performed (explained in detail below). As the positions of the clogged nozzles Nz are less locally concentrated and the number of the clogged nozzles Nz is smaller, a difference between an image after the supplementation and an image formed when normal discharge is performed is smaller.

In this embodiment, four image qualities are defined in advance according to the positions and the number of the clogged nozzles Nz. Specifically, four states are defined as follows based on the positions and the number of the clogged nozzles Nz: a state in which no clogged nozzle Nz is present, a state in which the number of the clogged nozzles Nz is small and the ink that should be discharged from the clogged nozzles Nz can be supplemented, a state in which the number of the clogged nozzles Nz is medium and the nozzles Nz that cannot be supplemented can remain, and a state in which the number of the clogged nozzles Nz is large and the supplementation does not function.

In this embodiment, the image quality of a print printed in the state in which no clogged nozzle Nz is present is referred as highest image quality. The image quality of a print printed in the state in which the number of the clogged nozzles Nz is small and the ink that should be discharged from the clogged nozzles Nz can be supplemented is referred to as high image quality. Further, the image quality of a print printed in the state in which the number of the clogged nozzles Nz is medium and the nozzles Nz that cannot be supplemented can remain is referred to as medium image quality. In this embodiment, printing in the state in which the number of the clogged nozzles Nz is large and the supplementation does not function is not performed. However, this state is referred to as low image quality.

In the example shown in FIG. 3, the user is capable of setting image quality required for a print. In this embodiment, the user is capable of selecting first image quality and second image quality. In this embodiment, the second image quality is a mode in which printing is performed if printing in the highest image quality, the high image quality, or the medium image quality is possible and printing is not performed if only printing in the low image quality can be performed. On the other hand, the first image quality is a mode in which printing is performed if printing in the highest image quality or the high image quality is possible and printing is not performed if only printing in image quality equal to or lower than the medium image quality can be performed. However, when printing can be performed only in the medium image quality in the first image quality, printing may be executable according to setting by the user. For example, printing may be executed when the user performs setting to execute printing even at a printing trouble occurrence time when printing can be performed only in the medium image quality and printing may not be executed when the user performs setting not to execute printing. The setting may be implemented before a printing start or may be implemented after the printing start. In this embodiment, the setting is possible before the printing start.

As explained above, in the first image quality and the second image quality, the image quality of an obtained print can be different. In this embodiment, image quality expected as a state in which printing is always performed is higher in the first image quality than in the second image quality. Therefore, a user who selects the first image quality can be regarded as requesting higher image quality than a user who selects the second image quality. In FIG. 3, a user interface capable of selecting the first image quality or the second image quality is illustrated.

In an item of the number of times of automatic cleaning, the user can set the number of times of cleaning automatically performed in order to eliminate clogging of the nozzles Nz. The number of times of cleaning indicates an upper limit of the number of times of cleaning automatically executable within a default period in order to eliminate nozzle clogging. In this embodiment, the default period is a period from a start to an end of one print job. In an item of a printing trouble occurrence time, the user can select whether to continue printing, stop printing, or execute cleaning when, for example, clogging of the nozzles Nz occurs. In this embodiment, a situation in which printing can be performed only in the medium image quality in the first image quality is equivalent to a situation in which a printing trouble has occurred. Therefore, when printing is set to be continued in the item of the printing trouble occurrence time, printing can be executed even if the printing can be performed only in the medium image quality in the first image quality. The control section 10 controls the UI section 80 to display the user interface shown in FIG. 3. When the user performs operation on the user interface, the control section 10 receives setting corresponding to the operation and causes the nonvolatile memory 90 or the like to store information indicating setting content.

The control section 10 refers to information indicating the setting content when executing a print job and executes detection according to the setting implemented in the user interface shown in FIG. 3. In this embodiment, when detection is performed, the control section 10 prints a check pattern and scans the check pattern with the CIS 60a of the detecting section 60. Specifically, the control section 10 controls the conveying mechanism 40 to convey a printing medium such that a target region where the check pattern is printed is arranged in a printing position by the print head 20. The control section 10 controls the print head 20 to print a default check pattern. The check pattern only has to be a pattern from which presence or absence and a degree of an abnormality of the printing mechanism M (in this embodiment, clogging of the nozzles Nz) can be estimated and may be various patterns.

When the check pattern is printed, the control section 10 controls the conveying mechanism 40 to reversely convey the printing medium to arrange the check pattern in a scan position by the CIS 60a of the detecting section 60. The control section 10 controls the detecting section 60 to read the check pattern with the CIS 60a. When the check pattern is read, the control section 10 records scan data indicating a read result in the nonvolatile memory 90 or the like. The control section 10 detects clogging of the nozzles Nz based on the scan data. The clogging of the nozzles Nz may be detected by various methods. For example, when ink is not recorded in positions where dots and lines should be recorded in the check pattern and the ink in adjacent positions has proper density, it is specified that the nozzles Nz that should discharge the unrecorded ink are clogged. When the ink is not recorded (or is thin) in the positions where the dots and the lines should be recorded and the ink in the adjacent positions is denser than a reference, it is specified that a flying direction of the ink from the nozzles Nz that should discharge the unrecorded ink (or the nozzles Nz that should discharge the thin ink) is abnormal.

In the embodiment, when clogging of the nozzles Nz is detected, the control section 10 attempts supplementation of the clogged nozzles Nz and elimination of the clogging. The supplementation is processing for supplementing the ink that should be discharged by the clogged nozzles Nz with the ink discharged by the other nozzles Nz. The supplementation may be performed by various methods. For example, the ink that should be discharged by the clogged nozzles Nz can be supplemented by increasing an amount of the ink discharged from at least one of the nozzles Nz (adjacent nozzles Nz or the like) present around the clogged nozzles Nz. For example, the ink that should be discharged by the clogged nozzles Nz can be supplemented by controlling the carriage and the conveying mechanism 40 of the print head 20 and moving the nozzles Nz different from the clogged nozzles Nz to discharge positions of the ink by the clogged nozzles Nz to discharge the ink.

The supplementation is implemented to supplement the ink that should be discharged from the clogged nozzles Nz with the ink discharged by the other nozzles Nz. However, whether all of the clogged nozzles Nz are supplemented depends on the positions of the clogged nozzles Nz, the number of the clogged nozzles Nz, and the like in the print head 20. When a plurality of clogged nozzles Nz are present in a local region in the nozzle plate 22, for example, when all of a plurality of nozzles Nz adjacent to a certain nozzle Nz are clogged, the supplementation by the surrounding nozzles Nz is sometimes impossible. That is, states of the nozzles Nz can be a state in which clogging of the nozzles Nz has not occurred and the supplementation is unnecessary, a state in which clogging of the nozzles Nz has occurred but the supplementation is possible, and a state in which the supplementation for the clogged nozzles Nz is impossible.

Printing results obtained in the respective states are image qualities corresponding to presence or absence of the supplementation and presence of clogging of the nozzles Nz. However, when the user views the obtained printing results, it is not always evident at a glance in which of the states the printing results are obtained. Therefore, in this embodiment, the control section 10 performs printing such that a degree of an abnormality of the printing mechanism M at the time when printing is performed can be grasped at a glance.

Accordingly, the control section 10 specifies presence or absence of an abnormality of the printing mechanism M and a degree of the abnormality based on a detection result of the CIS 60a of the detecting section 60. Specifically, the control section 10 refers to the nonvolatile memory 90 and specifies presence or absence of clogging of the nozzles Nz based on the latest scan data. The control section 10 regards that an abnormality is absent when clogging of the nozzles Nz has not occurred and the supplementation is unnecessary and regards that an abnormality is present when clogging of the nozzles Nz has occurred.

When the clogging of the nozzles Nz has occurred, the control section 10 further refers to the nonvolatile memory 90 and specifies the positions of the clogged nozzles Nz based on the latest scan data. The control section 10 specifies a state of the nozzles Nz based on the positions and the number of the clogged nozzles Nz. Specifically, the control section 10 specifies, based on the positions and the number of the clogged nozzles Nz, in which a state where no clogged nozzle Nz is present, a state in which the number of the clogged nozzles Nz is small and the ink that should be discharged from the clogged nozzles Nz can be supplemented, a state in which the number of the clogged nozzles Nz is medium and the nozzles Nz that cannot be supplemented can remain, and a state in which the number of the clogged nozzles Nz is large and the supplementation does not function the nozzles Nz is. When no clogged nozzle Nz is present, the control section 10 regards that there is no abnormality in the nozzles Nz. When the clogged nozzles Nz are present, the control section 10 regards that there is an abnormality in the nozzles Nz. As the number of the clogged nozzles Nz is larger, the control section 10 determines that a degree of an abnormality is heavier.

It is specified by the positions and the number of the clogged nozzles Nz whether the supplementation for the nozzles Nz is possible or impossible. It is possible to adopt, for example, a configuration for determining that the supplementation is possible when the number of the clogged nozzles Nz per section area is equal to or smaller than an upper limit value and determining that the supplementation is impossible when the number of the clogged nozzles Nz per section area exceeds the upper limit value. It goes without saying that this determination method is an example. It is also possible to adopt another determination method, for example, a configuration for, for each of the clogged nozzles Nz, performing processing for specifying the nozzles Nz that supplement the ink and, when the nozzles Nz that supplement the ink are successfully specified without redundantly selecting the nozzles Nz, determining that the supplementation is possible.

The control section 10 performs printing to form a different margin according to presence or absence of clogging of the nozzles Nz and a degree of the clogging of the nozzles Nz. That is, the control section 10 performs printing to differentiate the length of a printing medium after cutting according to presence or absence of clogging of the nozzles Nz and a degree of the clogging of the nozzles Nz. Specifically, when the printing medium is cut by the cutter 50 after the printing is performed, the control section 10 changes presence or absence of a margin and the length (the size in the conveying direction) of the margin and varies the shape of the printing medium according to presence or absence of clogging of the nozzles Nz and a degree of the clogging.

As a result, the user can grasp, based on a difference in the length (the size in the conveying direction) of the printing medium caused by the difference in the margin of the printing medium, in what kind of a state of clogging of the nozzles Nz a printing result is printed. In this embodiment, since the length of the printing medium after the cutting is different according to presence or absence and a degree of clogging of the nozzles Nz, the user can learn the presence or absence and the degree of the clogging of the nozzles Nz by glancing the printing medium after the printing. Further, if printing media different in the presence or absence and the degree of the clogging of the nozzles Nz are put side by side, the user can more clearly grasp the presence or absence and the degree of the clogging of the nozzles Nz. Further, in this embodiment, since the length of the margin of the printing medium can be adjusted by the cutter 50, it is possible to extremely easily adjust the margin to have length corresponding to the presence or absence and the degree of the clogging of the nozzles Nz.

### 2. PRINT PROCESSING

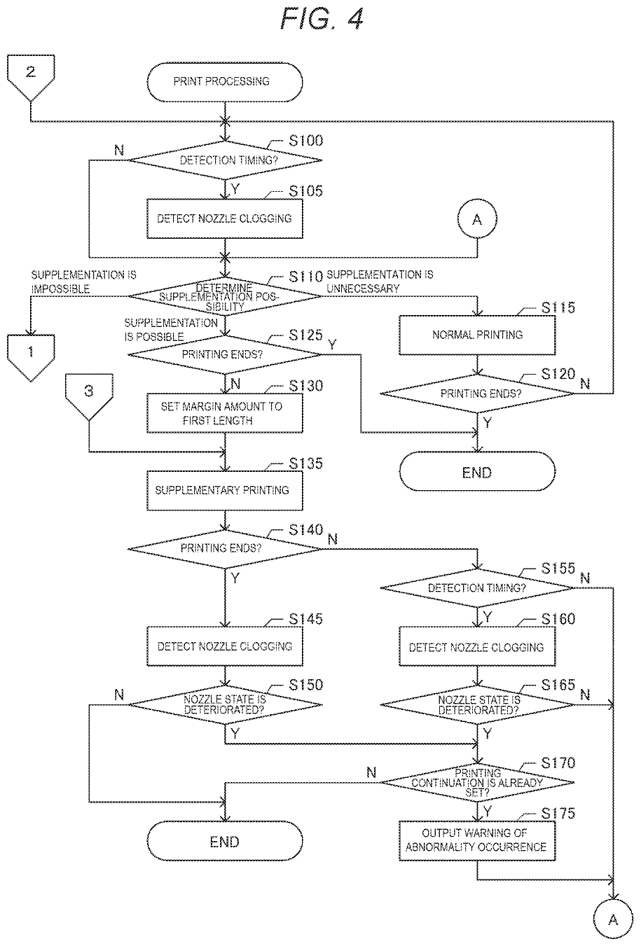

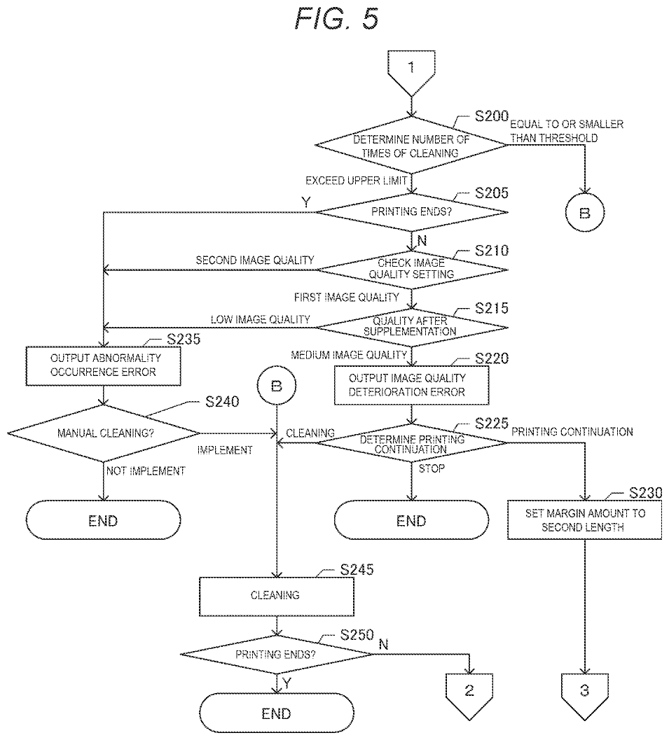

Print processing in the printing apparatus 100 is explained in detail. Before starting the print processing, the user performs various kinds of setting using the user interface shown in FIG. 3. In a state in which the setting is performed, when the user generates a print job and instructs execution of the print processing by operating the personal computer, the UI section 80, or the like, the control section 10 executes the print processing shown in FIGS. 4 and 5.

When the print processing is started, the control section 10 determines whether it is detection timing for nozzle clogging (step S100). That is, the control section 10 specifies, based on conditions set by the user interface shown in FIG. 3, whether it is the detection timing for nozzle clogging.

Whether it is the detection timing is determined based on whether the present situation matches the conditions set by the user. For example, when automatic detection is set in the item of pre-printing detection, it is determined in step S100 immediately after the print processing that it is the detection timing.

On the other hand, the print processing sometimes repeatedly returns to step S100 according to loop processing included in the print processing. Printing of any number of pages is sometimes executed in this process. Therefore, the control section 10 determines according to the number of pages printed after nozzle clogging detection is performed last time whether it is the detection timing. Specifically, when n (n is a natural number of 1 to 100) is set in the number of printing pages in the item of the periodical detection of the user interface shown in FIG. 3, the control section 10 specifies the number of pages printed after nozzle clogging detection is performed last time and, if the number of pages is n, determines that it is the detection timing. When 0 is set in the number of printing pages in the item of the periodical detection of the user interface shown in FIG. 3, the control section 10 determines that it is not the detection timing.

When it is determined in step S100 that it is the detection timing, the control section 10 executes step S105. When it is not determined in step S100 that it is the detection timing, the control section 10 skips step S105. In step S105, the control section 10 detects nozzle clogging (step S105). That is, the control section 10 controls the conveying mechanism 40 to convey a printing medium and controls the print head 20 to print a check pattern. The control section 10 controls the conveying mechanism 40 to convey the printing medium, reads the check pattern with the CIS 60a of the detecting section 60, and records scan data in the nonvolatile memory 90. Further, the control section 10 specifies presence or absence of clogging of the nozzles Nz and the positions of the clogged nozzles Nz based on the latest scan data.

Subsequently, the control section 10 determines whether supplementation can be performed such that printing is performed in the image quality requested in the image quality setting set by the user interface shown in FIG. 3 (step S110). That is, the control section 10 specifies presence or absence of clogging of the nozzles Nz and a degree of the clogging based on the detection result of step S105 and determines whether the supplementation is possible. Specifically, when no clogging of the nozzles Nz is present, that is, printing can be performed in the highest image quality, the control section 10 determines that the supplementation is unnecessary. When the clogged nozzles Nz are present, the control section 10 specifies, based on the positions of the clogged nozzles Nz, the number of the clogged nozzles Nz, and the like, which of the high image quality, the medium image quality, and the low image quality image quality obtained in the printing by the supplementation is.

When printing is performed in the image quality requested by the setting based on the image quality setting, the control section 10 determines that the supplementation is possible. When printing is not performed in the requested image quality, the control section 10 determines that the supplementation is impossible. In this embodiment, the first image quality is a mode in which printing is performed if printing in the highest image quality in which the supplementation is unnecessary is possible or printing in the high image quality is possible by the supplementation and printing is not performed if only printing in the image quality equal to or lower than the medium image quality can be performed. Therefore, when the image quality is set to the first image quality, the control section 10 determines that the supplementation is possible if the image quality obtained in the printing by the supplementation is the high quality. If the image quality obtained in the printing by the supplementation is the medium image quality or the low image quality, the control section 10 determines that the supplementation is impossible.

On the other hand, the second image quality is a mode in which printing is performed if printing in the highest image quality in which the supplementation is unnecessary or printing in the high image quality or the medium image quality is possible by the supplementation and printing is not performed if only printing in the low image quality can be performed. Therefore, when the image quality is set to the second image quality, the control section 10 determines that the supplementation is possible if the image quality obtained in the printing by the supplementation is the high image quality or the medium image quality. If the image quality obtained in the printing by the supplementation is the low image quality, the control section 10 determines that the supplementation is impossible. With the configuration explained above, even if the same nozzles Nz are clogged, the control section sometimes determines that the supplementation is impossible when the image quality setting indicates the first image quality and determines that the supplementation is possible when the image quality setting indicates the second image quality.

When determining in step S110 that the supplementation is unnecessary, that is, when the image quality is the highest image quality, the control section 10 executes normal printing (step S115). Specifically, the control section 10 controls the conveying mechanism 40 and the print head 20 and prints one page of a printing target image on the printing medium according to the print job. When the printing is performed, the control section 10 controls the cutter 50 to cut the printing medium. In the case of the normal printing, the control section 10 cuts the printing medium to be a default size. In this embodiment, a plurality of sizes such as an A4 size and a B5 size are possible as the default size. However, the default size is designated in advance by the user or the like in the print job.

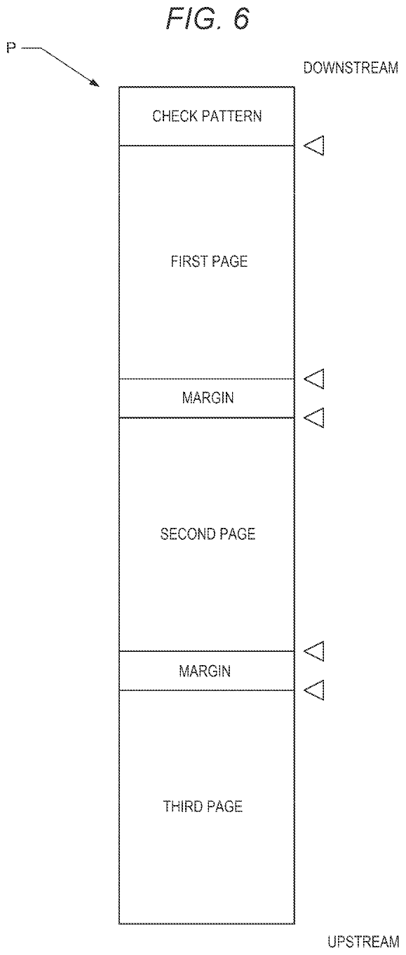

FIG. 6 is a schematic diagram for explaining cutting positions of the printing medium P. In FIG. 6, the printing medium P is indicated by a rectangle long in a longitudinal direction. In FIG. 6, an upward direction of the rectangle is the downstream of the conveying direction and a downward direction of the rectangle is the upstream of the conveying direction. In FIG. 6, the check pattern printed in step S105 immediately after the printing start and printing regions of a first page to a third page printed thereafter are schematically shown. In this embodiment, margins are provided among the pages. Since the margins are portions not forming the pages, in the normal printing, the printing medium P is cut not to leave the margins.

In FIG. 6, the cutting positions are indicated by triangle marks on the right side of the printing medium P and cutting lines on the printing medium P are indicated by solid straight lines. As shown in FIG. 6, the control section 10 does not leave the margins among the pages by cutting the printing medium P at upstream ends and downstream ends of the margins. Therefore, when a page having the default size is obtained, the user can recognize that supplementation for clogging of the nozzles Nz is unnecessary, that is, clogging of the nozzles Nz has not occurred. In the example shown in FIG. 6, a margin is absent between the check pattern and the first page. However, a margin may be provided between the check pattern and the first page. In the case of the normal printing, margins may not be provided among the pages and the printing medium may be cut in boundaries among the pages. The cutting of the printing medium may be implemented at various timings. For example, the printing medium may be cut every time printing of one page is performed or may be cut in a stage when a position of the printing medium to be cut reaches a cutting position by the cutter 50 in a process for continuously printing a plurality of pages. Cutting for a plurality of pages may be performed when the print job ends.

When the normal printing ends, the control section 10 determines whether the printing by the print job ends (step S120). That is, the control section 10 determines whether the printing by the print job ends in the stage of step S125. The end of the print job is specified by an end code or the like included in the print job. If the processing is executed to the end code and an error does not occur, the control section 10 can specify that the printing ends. When determining in step S120 that the printing by the print job ends, the control section 10 ends the print processing. When not determining in step S120 that the printing by the print job ends, the control section 10 repeats the processing in step S100 and subsequent steps.

On the other hand, when determining in step S110 that the supplementation is possible, the control section 10 determines whether the printing by the print job ends (step S125). The determination processing is the same as the processing in step S120. When determining in step S125 that the printing by the print job ends, the control section 10 ends the print processing.

When not determining in step S125 that the printing by the print job ends, the control section 10 sets a margin amount to first length (step S130). In this embodiment, two kinds of lengths are determined in advance as the length of a margin that is left without being cut in the printing medium. These lengths are first length indicating that printing is performed in a state in which the supplementation is possible and second length indicating that printing is performed in a state in which the supplementation is impossible. In this embodiment, 0<the first length<the second length. When the supplementation is impossible, a degree of an abnormality is heavier than when the supplementation is possible. Therefore, in this embodiment, the length of a margin is larger when the degree of the abnormality is heavier than when the degree of the abnormality is lighter. Therefore, according to this embodiment, the user can intuitively recognize the degree of the abnormality from the length of the margin.

Subsequently, the control section 10 executes supplementary printing (step S135). That is, the control section 10 controls the conveying mechanism 40 and the print head 20 according to the print job and specifies, based on the positions of the clogged nozzles Nz detected in step S105, the other nozzles Nz that supplement ink that should be discharged by the clogged nozzles Nz and an ink discharge amount in the other nozzles Nz. The control section 10 generates printing control data for printing one page of an image relating to the print job while supplementing the ink in the other nozzles Nz.

The control section 10 controls the conveying mechanism 40 and the print head 20 according to the printing control data and prints a printing target image on the printing medium. In printing the printing target image, the control section 10 controls the cutter 50, prints the printing target image on the printing medium to adjust the margin amount to the set length, and cuts the printing medium. When step S135 is executed through step S130, the set margin amount is the first length.

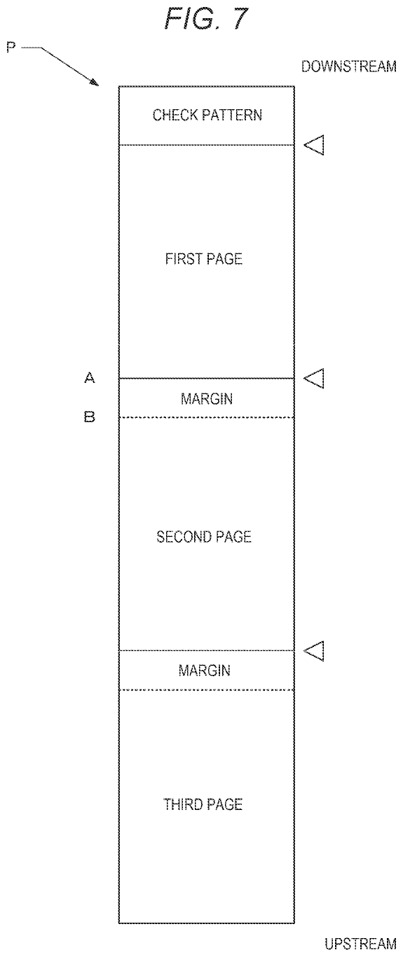

FIG. 7 is a schematic diagram for explaining cutting positions of the printing medium P at the time when a first page is normally printed and the supplementary printing is performed in a second page and a third page. The printing medium P is indicated by a rectangle long in the longitudinal direction in FIG. 7 as well. In FIG. 7, an upward direction of the rectangle is the downstream of the conveying direction and a downward direction of the rectangle is the upstream of the conveying direction. The check pattern printed in step S105 immediately after the printing start and printing regions of the first page to the third page printed thereafter are schematically shown. In FIG. 7, an example is shown in which it is determined in step S110 that the supplementation is possible. Therefore, the length of margins among the pages is the length of the margins set in step S130. The printing medium P is cut to leave the margins.

In FIG. 7 as well, cutting positions are indicated by triangle marks on the right side of the printing medium P. Cutting lines on the printing medium P are indicated by solid lines. Boundaries between the margins and the pages are indicated by broken lines. As shown in FIG. 7, the printing medium P is cut in a boundary between an upstream end of a page and a downstream end of a margin (for example, a position A) but is not cut in a boundary between a downstream end of the page and an upstream end of the margin (for example, a position B). In this way, when the supplementary printing is performed, margins are left on a printed printing medium. Therefore, when a page larger than a page having the default size is obtained, the user can recognize that clogging of the nozzles Nz is not absent and the supplementation has been performed. A boundary between a downstream end of the page and an upstream end of a margin (for example, the position B) is cut by the user when the user checks this printing result and determines that the printing result has no problem. Accordingly, printing for assisting the user in performing the cutting such as printing of a register mark may be performed in the boundary between the downstream end of the page and the upstream end of the margin (for example, the position B).

In this embodiment, steps S130 and S135 are executed through steps S110 and S125 if the supplementation is possible irrespective of whether the image quality setting by the user interface shown in FIG. 3 is either the first image quality or the second image quality. Therefore, the margin amount is the first length if the supplementation is possible irrespective of whether the image quality setting indicates either the first image quality or the second image quality.

When the supplementary printing is performed, the control section 10 determines whether the printing by the print job has ended (step S140). That is, since the printing by the print job is implemented for one page in step S135, the control section 10 determines whether the print processing by the print job has ended according to the printing of the page.

When determining in step S140 that the printing by the print job has ended, the control section 10 detects nozzle clogging (step S145). This processing is the same as the processing in step S105. When the detection is performed, scan data is recorded in the nonvolatile memory 90. Presence or absence of clogging of the nozzles Nz and the positions of the clogged nozzles Nz are specified.

Subsequently, the control section 10 determines whether a state of the nozzles Nz is deteriorated (step S150). That is, the control section 10 specifies, based on a detection result of step S145, presence or absence of clogging of the nozzles Nz and a degree of the clogging. For example, when, in the last detection of nozzle clogging, it is specified based on the detection in step S145 that a degree of clogging of the nozzles Nz is a degree that can be supplemented but it is specified based on the detection in step S145 that the degree of the nozzle clogging is deteriorated to a degree that cannot be supplemented, the control section 10 determines that the state of the nozzles Nz is deteriorated.

When not determining in step S150 that the state of the nozzles Nz is deteriorated, the control section 10 ends the print processing. When determining in step S150 that the state of the nozzles Nz is deteriorated, the control section 10 determines whether print continuation setting is already performed (step S170). That is, the control section 10 determines whether printing is set to be continued in the item of the printing trouble occurrence time in the user interface shown in FIG. 3.

When not determining in step S170 that the printing is set to be continued, the control section 10 ends the print processing. When determining in step S170 that the printing is set to be continued, the control section 10 controls the UI section 80 to output a warning of abnormality occurrence (step S175). That is, the control section 10 causes the UI section 80 to output display or sound indicating the abnormality occurrence and notifies the user that the state of the nozzles Nz is deteriorated.

Thereafter, the control section 10 executes the processing in step S110 and subsequent steps. However, when the state of the nozzles Nz is deteriorated, since the control section 10 determines in step S110 that the supplementation is impossible, the control section 10 executes processing in step S200 and subsequent steps explained below. The configuration explained above is an example. The warning may be performed irrespective of whether the printing is set to be continued. If the print job ends, the warning may be omitted. In this case, the warning may be performed before the next print job is executed.

On the other hand, when not determining in step S140 that the printing by the print job has ended, the control section 10 determines whether it is detection timing for nozzle clogging (step S155). The processing is the same as in step S100 explained above. When not determining in step S155 that it is the detection timing, the control section 10 sets the next page as a printing target and repeats the processing in step S110 and subsequent steps.

When determining in step S155 that it is the detection timing, the control section 10 detects nozzle clogging (step S160). This processing is the same as the processing in step S105. When the detection is performed, scan data is recorded in the nonvolatile memory 90 and presence or absence of clogging of the nozzles Nz and the positions of the clogged nozzles Nz are specified.

Subsequently, the control section 10 determines whether the state of the nozzles Nz is deteriorated (step S165). That is, the control section 10 specifies presence or absence of clogging of the nozzles Nz and a degree of the clogging based on a detection result in step S160. This processing is the same as the processing in step S150. When not determining in step S165 that the state of the nozzles Nz is deteriorated, the control section 10 sets the next page as a printing target and repeats the processing in step S110 and subsequent steps.

When determining in step S165 that the state of the nozzles Nz is deteriorated, the control section 10 determines whether printing continuation setting is performed (step S170). That is, the control section 10 determines whether printing is set to be continued in the item of the printing trouble occurrence time in the user interface shown in FIG. 3. When not determined in step S170 that the printing is set to be continued, the control section 10 ends the print processing. In this case, a notification indicating that, for example, the printing is stopped because of the occurrence of nozzle clogging may be performed.

When determining in step S170 that the printing is set to be continued, the control section 10 controls the UI section 80 to output a warning of abnormality occurrence (step S175). That is, the control section 10 causes the UI Section 80 to output display or sound indicating the abnormality occurrence and notifies the user that the state of the nozzles Nz is deteriorated. Thereafter, the control section 10 sets the next page as a printing target and repeats the processing in step S110 and subsequent steps. That is, since the printing is set to be continue even if a printing trouble occurs, the control section 10 warns the user that image quality is likely to be deteriorated and then continues the printing.

When determining in step S110 that the supplementation is impossible, the control section 10 determines the number of times of cleaning (step S200). That is, the control section 10 specifies, as the number of times of cleaning implementation, the number of times of cleaning automatically implemented in a period from a start to an end of the print job. The control section 10 specifies, as an upper limit of the number of times of cleaning, the number of times of automatically executable cleaning set by the user in the user interface shown in FIG. 3. The control section 10 determines whether the number of times of cleaning implementation is equal to or smaller than the upper limit.

When determining in step S200 that the number of times of cleaning implementation is equal to or smaller than the upper limit, the control section 10 implements cleaning (step S245). That is, the control section 10 controls the conveying mechanism 40 to retract the printing medium from between the print head 20 and the cleaning mechanism 30 and controls the cleaning mechanism 30 to implement a default cleaning operation. The cleaning operation may change according to the number of times of cleaning or may be the same operation every time. The user may be able to instruct the cleaning operation.

Subsequently, the control section 10 determines whether the printing by the print job has ended (step S250). This processing is the same as the processing in step S120. When determining in step S250 that the printing by the print job has ended, the control section 10 ends the print processing. When not determining in step S250 that the printing by the print job has ended, the control section 10 repeats the processing in step S100 and subsequent steps.

When the cleaning is performed in step S245 and step S100 is executed through step S250, the control section 10 determines in step S100 that it is detection timing. Therefore, if the detection of nozzle clogging is performed in step S105 and the clogging of the nozzles Nz is eliminated by the cleaning, the normal printing is performed in step S115 through step S110. If the clogged state of the nozzles Nz is improved by the cleaning and the supplementation is possible, the supplementary printing is performed in step S135 through steps S110, S125, and S130. In this case, a printing result in which a margin has the first length is obtained.

When determining in step S200 that the number of times of cleaning implementation exceeds the upper limit, the control section 10 determines whether the printing by the print job has ended (step S205). This processing is the same as the processing in step S120. When determining in step S205 that the printing by the print job has ended, the control section 10 controls the UI section 80 to output an error of abnormality occurrence (step S235). That is, the control section 10 causes the UI section 80 to output display or sound indicating the abnormality occurrence and notifies the user that the nozzle clogging cannot be eliminated by the cleaning.

It is determined in step S205 that the printing by the print job has ended, for example after the supplementary printing is performed in step S135, when step S110 is executed through steps S140, S145, S150, S170, and S175 and it is determined in step S110 that the supplementation is impossible. This situation occurs, for example, when the state of the nozzles Nz changes, according to the supplementary printing in step S135, from the state in which the supplementation is possible to the state in which the supplementation is impossible. In this embodiment, since step S235 and step S175 are executed in this situation, both of the warning of the abnormality occurrence and the error are notified to the user. That is, although the print job ends, it is notified to the user that an abnormality that cannot be supplemented has occurred in the nozzles Nz.

When step S235 is executed, the control section 10 controls the UI section 80 to inquire of the user whether to execute manual cleaning (step S240). That is, the control section 10 causes the UI section 80 to output a user interface for inquiring of the user whether to manually perform cleaning. When the user operates the user interface and instructs not to manually perform cleaning, the control section 10 ends the print processing.

When the user operates the user interface and instructs to manually perform cleaning, the control section 10 implements the instructed cleaning (step S245) and determines whether the printing by the print job has ended (step S250). Since a state in which it is determined in step S205 that the printing by the print job has ended is assumed, the control section 10 ends the print processing through the determination in step S250. A method of the manual cleaning may be the same as or may be different from the method of the automatic cleaning.

On the other hand, when not determining in step S205 that the printing by the print job has ended, the control section 10 checks image quality setting (step S210) That is, the control section 10 determines which of the first image quality and the second image quality the image quality set in the item of the image quality setting in the user interface shown in FIG. 3 is. When determining in step S210 that the image quality setting indicates the second image quality, the control section 10 executes the processing in step S235 and subsequent steps.

The second image quality is a mode for performing printing if printing in the highest image quality, the high image quality, or the medium image quality is possible and not performing printing if only printing in the low image quality can be performed. Step S210 being executed in a state in which the image quality is set to the second image quality is a state in which a state of clogging of the nozzles Nz corresponds to a state of the low image quality and it is determined in step S110 that the supplementation is impossible. In the case of the printing in the low image quality in the state in which the image quality is set to the second image quality, the printing is not executed. Since the processing is performed in this way, the control section 10 outputs the error in step S235 and notifies the user that it is impossible to execute printing and, in step S240, inquires of the user whether to execute the manual cleaning.

When the manual cleaning is executed, steps S105 and S110 are executed through steps S245, S250, and S100. In this case, if the clogging state of the nozzles Nz is improved and the supplementation is possible or the supplementation is unnecessary, the supplementary printing in step S135 or the normal printing in step S115 is performed.

In this embodiment, when the image quality setting indicates the first image quality, the printing in the highest image quality or the high image quality is requested and the printing in the medium image quality and the low image quality is not requested. However, in this embodiment, in the case of the medium image quality, printing can be implemented if the user permits the printing. Therefore, when determining in step S210 that the image quality setting indicates the first image quality, in order to determine whether to perform the printing in the medium image quality, the control section 10 executes the processing in step S215 and subsequent steps.

In step S215, the control section 10 determines, based on a state of the nozzle clogging, which of the medium image quality and the low image quality image quality obtained in the printing by the supplementation is (step S215). The determination of the image quality is the same as in step S110 and only has to be implemented based on the positions and the number of the clogged nozzles Nz. When determining in step S215 that the image quality after the supplementation is the low image quality, the control section 10 regards the excessive number of the nozzles Nz is clogged and does not execute printing. Accordingly, the control section 10 executes the processing in step S235 and subsequent steps. In this case, the control section 10 outputs an error in step S235 and notifies the user that it is impossible to execute printing and, in step S240, inquires of the user whether to execute the manual cleaning.

When the manual cleaning is executed, steps S105 and S110 are executed through steps S245, S250, and S100. In this case, if the clogging state of the nozzles Nz is improved and the supplementation is possible or the supplementation is unnecessary, the supplementary printing in step S135 or the normal printing in step S115 is performed.

On the other hand, when determining in step S215 that the image quality after the supplementation is the medium image quality, the control section 10 outputs an image quality deterioration error (step S220). That is, the control section 10 causes the UI section 80 to output display or sound indicating that an abnormality of the printing mechanism M has occurred and notifies the user that the image quality in the printing result is likely to be deteriorated to be lower than the highest image quality or the high image quality, which is the image quality requested by the user. Subsequently, the control section 10 determines setting content of the printing continuation setting (step S225). That is, the control section 10 determines which of printing continuation, printing stop, and cleaning execution the content set in the item of the printing trouble occurrence time in the user interface shown in FIG. 3 is. The user may not implement the setting in advance. For example, in the stage of step S225, the control section 10 may cause the user to indicate which of the printing continuation, the printing stop, and the cleaning execution the content set in the item of the printing trouble occurrence time is.

When determining in step S225 that the printing is set to be continued, the control section 10 sets a margin amount to the second length (step S230). That is, the control section 10 sets the length of a margin to be the second length larger than the length of the margin set in step S130. Thereafter, the control section 10 executes the processing in step S135 and subsequent steps. That is, in step S135, the control section 10 controls the print head 20, the conveying mechanism 40, and the cutter 50 to perform printing and perform cutting to adjust the margin to the second length set in step S230. In this case, the printing by the medium image quality is performed.

As explained above, the second length is larger than the first length. When the image quality is set to the first image quality, the processing in steps S130 and S135 for setting the margin to the first length is executed when the image quality is the high image quality. The processing in steps S230 and S135 for setting the margin to the second length is executed when the image quality is the medium image quality. Therefore, when a printing medium including a margin is printed in a state in which the image quality is set to the first image quality and when the length of the margin is the second length larger than the first length, the user can intuitively recognize that the number of the clogged nozzles Nz is relatively large and the image quality is the medium image quality.

When determining in step S225 that the printing is set to be stopped, the control section 10 ends the print processing. When determining in step S225 that cleaning is set to be executed, the control section 10 executes the processing in step S245 and subsequent steps. When the cleaning is executed, steps S105 and S110 are executed through steps S245, S250, and S100. In this case, if the clogging state of the nozzles Nz is improved and the supplementation is possible or the supplementation is unnecessary, the supplementary printing in step S135 or the normal printing in step S115 is performed.

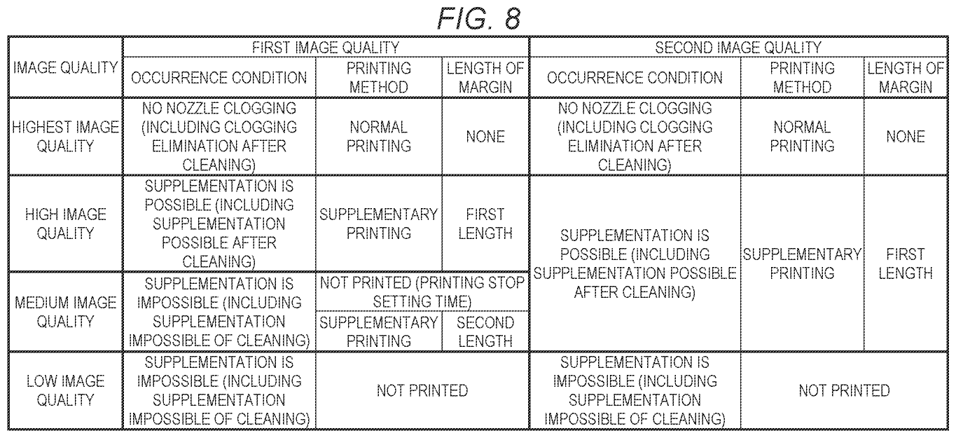

FIG. 8 is a diagram for explaining a situation that occurs when the print job does not end in the print processing explained above. As the degrees of the clogging of the nozzles Nz, as explained above, there are the four states, that is, the state in which no clogged nozzle Nz is present, the state in which the number of the clogged nozzles Nz is small, the state in which the number of the clogged nozzles Nz is medium, and the state in which the number of the clogged nozzles Nz is large. The image qualities corresponding to these states can be the highest image quality, the high image quality, the medium image quality, and the low image quality. The printing method is the normal printing or the supplementary printing.

In FIG. 8, occurrence conditions for the image qualities, printing methods in the case of the occurrence conditions, and lengths of margins are shown for each of image quality settings. When no clogged nozzle Nz is present and the image quality is the highest image quality, the normal printing is executed in step S115 through the determination in step S110. That is, when the image quality is the highest image quality, the normal printing is performed irrespective of whether the image quality is set to either the first image quality or the second image quality and the printing medium is printed without a margin and is cut.

Since step S110 can be repeatedly executed in the process of the loop processing, when the cleaning is performed in step S245 after it is determined in S110 that the supplementation is impossible, the number of the clogged nozzles Nz is sometimes zero. In this case, when the step S110 is executed again, it is determined that the supplementation is unnecessary. In this case, the normal printing is executed.

When the image quality is set to the first image quality, even if clogging of the nozzles Nz occurs, steps S130 and S135 are executed through the determination in step S110 if the number of the clogged nozzles Nz is small and image quality obtained in printing by supplementation is the high image quality. As a result, the supplementary printing is performed with a margin having the first length and the printing medium is cut to leave the margin having the first length. When the image quality is set to the second image quality, even if clogging of the nozzles Nz occurs, steps S130 and S135 are executed through the determination in step S110 if image quality obtained in printing by supplementation is the high image quality or the medium image quality. As a result, the supplementary printing is performed with the margin having the first length and the printing medium is cut to leave the margin having the first length.

Since the step S110 can be repeatedly executed in the process of the loop processing, the image quality is sometimes improved when the cleaning is performed in step S245 after it is determined in step S110 that the supplementation is impossible. In this case, when step S110 is executed again, it can be determined that the supplementation is possible. When the image quality is improved to make it possible to perform the supplementation, the supplementary printing is performed with the margin having the first length and the printing medium is cut to leave the margin having the first length.

When the image quality is set to the first image quality and the image quality obtained in the printing by the supplementation is the medium image quality or the low image quality, steps S205, S210, and S215 are executed through the determination in step S110. In this case, different kinds of processing are performed when the number of the clogged nozzles Nz is medium and when the number of the clogged nozzles Nz is large. When the image quality is the medium image quality, if the continuation of the printing is set, the margin amount is set to the second length through steps S225 and S230 and the supplementary printing is performed with the second length in step S135. If the stop of the printing is set, the printing is stopped through the determination in step S225. If the cleaning is set, step S245 is executed. However, printing is not performed unless the number of the clogged nozzles Nz decreases. When the image quality is the low image quality, steps S235 and S240 are executed through the determination in step S215. Therefore, printing is not performed unless a situation in which the number of the clogged nozzles Nz is large is changed by the cleaning.

When the image quality is set to the second image quality and the image quality obtained in the printing by the supplementation is the low image quality, steps S235 and S240 are executed through steps S110, S205, and S210. Therefore, unless the manual cleaning is executed, the image quality does not change and printing is not performed. On the other hand, when the manual cleaning is performed in step S245 and the image quality is improved to the medium image quality or the high image quality, it is determined in step S110 that the supplementation is possible. As a result, steps S130 and S135 are executed. That is, when the image quality is set to the second image quality, even if it is once determined that supplementation of the clogged nozzles Nz is impossible, the supplementary printing is performed with the margin having the first length if the number of the clogged nozzles Nz is reduced by the cleaning. The printing medium is cut to leave the margin having the first length. In this way, when the image quality is set to the second image quality, printing is not performed unless a supplementation impossible state changes. However, printing is performed if the supplementation is possible.

As explained above, in this embodiment, the applied printing method and the length of the margin left after the printing are different according to whether the image quality setting indicates the first image quality or the second image quality. The applied printing method and the length of the margin are different according to presence or absence of an abnormality of the printing mechanism M and a degree of the abnormality. Therefore, in this embodiment, a configuration for controlling the printing mechanism M to form a different margin according to presence or absence of an abnormality of the printing mechanism M, a degree of the abnormality, and image quality setting is adopted. With this configuration, the margin changed according to the presence or absence of an abnormality of the printing mechanism M and the degree of the abnormality can be further changed by the image quality setting. Therefore, compared with a configuration in which the margin cannot be changed by the image quality setting, it is possible to further vary meanings (the presence or absence of an abnormality of the printing mechanism M and the degree of the abnormality) indicated by the length of the margin.

Further, in this embodiment, when the image quality is set to the first image quality, the margin changes to the first length if the supplementary printing is performed in a state in which printing in the high image quality is possible. On the other hand, the margin changes to the second length if the supplementary printing is performed in a state in which printing in the medium image quality is possible. If the state in which the printing in the high image quality is possible is regarded as a degree of a first abnormality and the state in which the printing in the medium image quality is possible is regarded as a degree of a second abnormality, in the degree of the first abnormality, the printing mechanism M is controlled to form a margin different from the degree of the second abnormality.

When the image quality setting indicates the second image quality, the margin changes to the first length if the supplementary printing is performed in the state in which the printing in the high image quality is possible and the state in which the printing in the medium image quality is possible. On the other hand, in the state of the low image quality, printing is not performed unless the image quality is improved by the cleaning to be equal to or higher than the medium image quality. In this configuration, since the length of the margin is the first length in both of the high image quality and the medium image quality, the control of the printing mechanism M for forming a different margin according to a degree of an abnormality is not performed. Therefore, when the state in which the printing in the high image quality is possible is regarded as the degree of the first abnormality and the state in which the printing in the medium image quality is possible is regarded as the degree of the second abnormality, the control of the printing mechanism M for forming a different margin in the degree of the first abnormality and the degree of the second abnormality is not performed when the image quality setting indicates the second image quality.

As explained above, printing can be performed by, in the second image quality, not setting length of a margin corresponding to a degree of an abnormality of the printing mechanism M and setting length of a margin corresponding to presence or absence of an abnormality of the printing mechanism M and, in the first image quality, setting length of a margin corresponding to, in addition to the presence or absence of an abnormality of the printing mechanism M, a degree of the abnormality of the printing mechanism M. Accordingly, the user can designate, with the image quality setting, whether the degree of the abnormality of the printing mechanism M is distinguished.

Further, in this embodiment, a margin is not formed when the number of the clogged nozzles Nz is zero, that is, when the image quality is the highest image quality. In the first image quality, the length of the margin is zero, the first length, and the second length when the image quality is the highest image quality, the high image quality, and the medium image quality. In this embodiment, since the second length is larger than the first length, a larger margin is formed when a relatively heavy abnormality is present in the printing mechanism M than when a relatively light abnormality is present in the printing mechanism M. Accordingly, the user can grasp severity of an abnormality based on the length of the margin. Therefore, it is easy to inspect a print.

### 3. OTHER EMBODIMENTS

The embodiment explained above is an example for carrying out the present disclosure. Besides the embodiment, various embodiments can be adopted. For example, the present disclosure may be applied to a multifunction peripheral device including an image reading function and a facsimile transmitting function besides a printing function.

The printing medium only has to be a target that is changed to a print by performing printing. The printing medium is not limited to paper. For example, cloth or a disk printing medium may be a printing target printing medium. The printing medium may be stored in various forms and is not limited to be stored in a roll form. For example, the printing medium cut into a default size may be stored and conveyed piece by piece.

The printing mechanism only has to be a mechanism capable of performing printing on the printing medium. Therefore, the printing mechanism may be a serial printer, a line printer, or a page printer. The printing mechanism is not limited to the print head of an ink jet type that discharges the ink explained above and may be, for example, a print head of an electrophotographic type that transfers toner onto a printing medium. It goes without saying that the printing mechanism may be a printing mechanism of another printing type, for example, a thermal transfer type or a dot impact type.

The conveying mechanism only has to be able to convey the printing medium. The conveyance only has to be implemented to enable a printed print to be used. For example, a conveying mechanism for conveying the printing medium stored in a default part to a part where printing is performed by the print head and conveying the printed printing medium to a part where the user can use the printing medium is adopted. As a conveying method, a method depending on a storing method for the printing medium may be adopted. If the printing medium is stored in the roll form, the conveying mechanism is a conveying mechanism for pulling out and conveying the printing medium. If the printing medium is cut into the default size, the conveying mechanism is a conveying mechanism for taking out and conveying the printing medium piece by piece.

The printing mechanism may include mechanisms other than the print head and the conveying mechanism. Such mechanisms are not limited to the cutter and the cleaning mechanism in the embodiment explained above. For example, a detecting mechanism for an end portion of the printing medium and a detecting mechanism for a conveyance abnormality of the printing medium may be included in the printing mechanism.

The detecting section only has to be able to detect an abnormality of the printing mechanism. The abnormality is not limited to the clogging of the nozzles and the abnormality of the discharging direction explained above and may be, for example, an abnormality of an ink discharge amount and an abnormality of a moving direction of the print head. That is, if presence or absence of various abnormalities affecting a printing result and degrees of the abnormalities are detected by the detecting section, it is possible to control the printing mechanism to form a margin corresponding to the presence or absence of the abnormalities and the degrees of the abnormalities.

It goes without saying that, if a type of the print head is different, a form of an abnormality can be different. For example, when the printing type is the electrophotographic type, an abnormality of a toner transfer amount, deviation of the toner transfer amount from a reference due to a position, and the like can be abnormalities. An abnormality of the printing mechanism is not limited to the abnormality of the print head. For example, if the quality of a printing result of the printing medium can be deteriorated by an abnormality of the conveying mechanism, the abnormality of the conveying mechanism may be detected as the abnormality of the printing mechanism. If the quality of the printing result is deteriorated by an abnormality of conveying speed, the abnormality of the conveying speed is detected as the abnormality of the printing mechanism.

Further, various methods can be adopted as the method of the supplementation as well. In this embodiment the same supplementation method is adopted irrespective of the image quality setting. However, a different supplementation method may be adopted according to the image quality setting. A different supplementation method may be adopted according to a type of a detected abnormality.

The control section only has to be able to control the printing mechanism to form a different margin according to presence or absence of an abnormality of the printing mechanism and a degree of the abnormality. That is, when any object is printed, the printing mechanism is controlled to differentiate a margin according to presence or absence of an abnormality of the printing mechanism and further differentiate the margin according to a degree of the abnormality of the printing mechanism. The degree of the abnormality may be defined by an indicator that changes stepwise or may be defined by an indicator that continuously changes.

When the degree of the abnormality is defined by the indicator that changes stepwise, the degree of the abnormality is defined to be abnormalities of at least two stages. In this case, there are at least three cases, that is, a case in which there is no abnormality, a case in which there is an abnormality of a first degree, and a case in which there is an abnormality of a second degree. Therefore, in this case, printing can be performed with at least three types of different margins. Length of 0 may be regarded as a margin. That is, the three types of margins may be three types in which lengths are 0 cm, 1 cm, and 2 cm or may be three types in which lengths are 1 cm, 2 cm, and 3 cm. The degree of the abnormality may be determined in three or more stages.

The degree of the abnormality only has to correspond to the magnitude of influence on the printing result and only has to correspond to severity, seriousness, or the like of the abnormality. The degree of the abnormality may be evaluated by various methods, may be evaluated by, for example, the number of clogged nozzles, or may be evaluated by, for example, comparison of a scanned image and a reference image. Various configurations can be adopted as the evaluation of the degree of abnormality. The setting of the image quality is not limited to the two types and may be one type or may be three or more types.

The margin is a region excluding a region where printing of an object can be performed in the printing medium. Typically, the margin is present in the outer periphery of the printing medium. In a rectangular print, a region along four sides is a margin. However, the margin is not limited to this. A margin, which is a target of length adjustment, may be an upstream end of a page, a downstream end of the page, or both of the upstream end and the downstream end. If margins at left and right ends can be adjusted, the length in the main scanning direction of the margins may be adjusted at least in a part of the left and right ends.

The margin only has to be different according to presence or absence of an abnormality and a degree of the abnormality. The difference of the margin may be determined according to various elements. Therefore, the margin is not limited to be printed to be different because the size of the printing medium is different according to the difference in the length of the margin as in the embodiment explained above. For example, the shape of the margin may be different. In this case, the shape of the printing medium may be different. The margin only has to be a region excluding a region where a printing target object is printed. Various marks (a mark of a cutting position and the like), characters, and the like may be printed in the margin to make the margin different.

The control section controls the cutter to differentiate the shape of the printing medium according to presence or absence of an abnormality of the printing mechanism and a degree of the abnormality. A form for controlling the cutter is not limited to the form explained in the embodiment. That is, various configurations can be adopted besides the configuration in which the conveyance amount by the conveying mechanism is different according to presence or absence of an abnormality of the printing mechanism and a degree of the abnormality. For example, the shape of the printing medium may be controlled to be different according to presence or absence of an abnormality of the printing mechanism and a degree of the abnormality by changing the position and the direction of the cutter. A plurality of cutters may be provided and a cutter to be used may be controlled to be different according to presence or absence of an abnormality of the printing mechanism and a degree of the abnormality. The printing apparatus may not include the cutter and may cause the user to cut the printing medium after printing completion. In that case, a position where the control section causes the user to cut the printing medium may be indicated by a register mark or the like. A margin indicated by the register mark or the like may be changed according to an abnormality.

How the degree of the abnormality of the printing mechanism is distinguished is not limited to the embodiment explained above. For example, a threshold for distinguishing the degree of the abnormality is optional. The user may be or may not be capable of designating the threshold. The same threshold may be used irrespective of the image quality setting. However, a different threshold may be used for each image quality setting.

Further, the present disclosure can also be applied as a program executed by a computer or a simple method and can also be applied as a method of producing a print. The system, the program, and the method explained above are sometimes realized as an independent device or are sometimes realized using components included in a plurality of devices and include various forms. The system, the program, and the method can be changed as appropriate, for example, a part thereof is software and a part thereof is hardware. Further, the present disclosure is realized as a recording medium for a program for controlling the system. It goes without saying that the recording medium for the program may be a magnetic recording medium or may be a semiconductor memory. Any recording medium to be developed in future can be considered completely the same.

What is claimed is:

1. A printing apparatus comprising:
a printing mechanism including:
a print head configured to perform printing on a printing medium; and
a conveying mechanism configured to convey the printing medium;
a detecting section configured to detect an abnormality of the printing mechanism; and
a control section configured to control the printing mechanism to form a different margin according to presence or absence of the abnormality of the printing mechanism and a degree of the abnormality.

2. The printing apparatus according to claim 1, wherein
the printing mechanism includes a cutter configured to cut the printing medium on which the printing is performed, and
the control section causes the cutter to cut the printing medium to differentiate a shape of the printing medium according to the presence or absence of the abnormality of the printing mechanism and the degree of the abnormality.

3. The printing apparatus according to claim 1, wherein
the print head includes a plurality of nozzles that discharge ink, and
the abnormality of the printing mechanism is clogging of the nozzles.

4. The printing apparatus according to claim 1, wherein the control section increases the margin as the number of clogged nozzles increases.

5. The printing apparatus according to claim 1, wherein the control section controls the printing mechanism according to image quality setting indicating image quality of the printing and controls the printing mechanism to form the different margin according to the presence or absence of the abnormality of the printing mechanism, the degree of the abnormality, and the image quality setting.

6. The printing apparatus according to claim 5, wherein the control section controls the printing mechanism to form, in a first abnormality degree, the margin different from the margin in a second abnormality degree when the image quality indicated by the image quality setting indicates first image quality and controls the printing mechanism not to form the different margins in the first abnormality degree and the second abnormality degree when the image quality indicated by the image quality setting indicates second image quality having lower requested image quality than the first image quality.

7. The printing apparatus according to claim 1, wherein the control section controls the printing mechanism to form the margin having different length according to the presence or absence of the abnormality of the printing mechanism and the degree of the abnormality.

8. The printing apparatus according to claim 1, wherein the control section controls the printing mechanism not to form the margin if there is no abnormality in the printing mechanism and, when there is a heavy abnormality in the printing mechanism, to form the margin larger than the margin formed when there is a light abnormality in the printing mechanism.

9. A print producing method comprising, in a printing apparatus including:
a printing mechanism including:
a print head configured to perform printing on a printing medium; and
a conveying mechanism configured to convey the printing medium;
a detecting section configured to detect an abnormality of the printing mechanism; and
a control section configured to control the printing mechanism,
the control section controlling the printing mechanism to form a different margin according to presence or absence of the abnormality of the printing mechanism and a degree of the abnormality and performing printing on the printing medium.
